(19) United States
(12) Patent Application Publication
(10) Pub. No.: US 2011/0227667 A1
(43) Pub. Date: Sep. 22, 2011

(54) WAVEGUIDE TYPE RAT-RACE CIRCUIT AND MIXER USING SAME

(76) Inventor: Hiroshi Uchimura, Kirishima (JP)

(21) Appl. No.: 13/131,210

(22) PCT Filed: Oct. 30, 2009
(86) PCT No.: PCT/JP2009/068662

§ 371 Date: May 25, 2011

(30) Foreign Application Priority Data
Nov. 26, 2008 (JP) 2008-300723

(51) Int. Cl. H01P 5/12

(52) U.S. Cl. 333/109

(57) ABSTRACT

Disclosed is a waveguide type rat-race circuit capable of being used suitably in a high-frequency region; further disclosed is a mixer using said circuit. This waveguide type rat-rate circuit is equipped with a circular waveguide part (30) that is provided with first-fourth ports (11-14) and that is partitioned into a first waveguide part (21) which connects the first and second ports, a second waveguide part (22) which connects the second and third ports, a third waveguide part (23) which connects the third and fourth ports, and a fourth waveguide part (24) which connects the fourth and first ports. The amount of phase shift of the first-third waveguide parts is (2n+1)π/2, and the difference between the sum of the amounts of phase shift of the first-third waveguide parts and the amount of phase shift of the fourth waveguide part is 2(m−1)π. This waveguide type rat-rate circuit is capable of being used suitably in a high-frequency region.

### TECHNICAL FIELD

The present invention relates to a rat race circuit often used in a high-frequency circuit, and particularly relates to a waveguide-type rat race circuit using a waveguide-type transmission line and to a mixer using the waveguide-type rat race circuit.

### BACKGROUND ART

A rat race circuit is known as a circuit used as a phase-shift circuit or a directional coupling circuit in a high-frequency circuit. With four input/output ports at specific positions of an annular transmission line having a specific length, a rat race circuit realizes a function of a phase-shift circuit or a directional coupling circuit. A rat race circuit using a strip line or a microstrip line as an annular transmission line is known (see, e.g., Patent Literature (PTL) 1). Since the positions of the four input/output ports on the annular transmission line are limited, the configuration of the transmission line for inputting or outputting an electric signal to or from the rat race circuit is limited. As a solution to such a problem specific to the rat race circuit, a rat race circuit using a three-dimensional wiring structure has been proposed (see, e.g., PTL 2).

### Citation List

### Patent Literature

PTL 1: Japanese Unexamined Patent Application Publication No. 2001-292012

PTL 2: Japanese Unexamined Patent Application Publication No. 11-308026

### SUMMARY OF INVENTION

### Technical Problem

However, conventional rat race circuits, such as those proposed in PTLs 1 and 2, have some problems as follows.

A first problem is that characteristics of the rat race circuit degrade with increasing frequency of an electric signal used. A conventional rat race circuit forms an annular transmission line using a strip line or a microstrip line. Since this causes an increase in transmission loss in the annular transmission line with increasing frequency, a loss in the rat race circuit increases.

A second problem is that the configuration of the transmission line for inputting or outputting an electric signal to or from the rat race circuit is limited. The rat race circuit includes an annular transmission line, and the positions of the four input/output ports on the annular transmission line are limited. Since this limits the configuration of the transmission line for inputting or outputting an electric signal to or from the rat race circuit, the transmission line for signal input/output can be pulled out only in a specific direction. As a solution to this problem, the rat race circuit using a three-dimensional wiring structure is described in PTL 2. Even in this rat race circuit, however, the configuration of the transmission line for signal input/output is limited. Additionally, changes in impedance caused by three-dimensional wiring result in reflection of an electric signal, and lead to degradation of electrical characteristics of the rat race circuit.

The present invention has been devised in view of the problems with the related art described above. An object of the present invention is to provide a waveguide-type rat race circuit that can be suitably used in a high-frequency region as high as the millimeter waveband or higher, and a mixer that uses the waveguide-type rat race circuit.

### Solution to Problem

In a waveguide-type rat race circuit according to the present invention, wall of an annular waveguide unit is provided with a first port, a second port, a third port, and a fourth port spaced from each other. The annular waveguide unit is divided into a first waveguide section that connects the first port and the second port, a second waveguide section that connects the second port and the third port, a third waveguide section that connects the third port and the fourth port, and a fourth waveguide section that connects the fourth port and the first port. At frequencies used by the waveguide-type rat race circuit, the amount of phase shift in each of the first waveguide section, the second waveguide section, and the third waveguide section is (2n+1)π/2, where n is a natural number; and a difference between a sum of the amounts of phase shift in the first waveguide section, the second waveguide section, and the third waveguide section and the amount of phase shift in the fourth waveguide section is 2(m−1)π, where m is a natural number.

In the waveguide-type rat race circuit according to the present invention, in the configuration described above, annular upper and lower walls of the annular waveguide unit each serve as an H-plane, and at least one of the first to fourth ports is formed in the upper wall or the lower wall of the annular waveguide unit.

In the waveguide-type rat race circuit according to the present invention, in the configuration described above, the port in the upper wall or the lower wall of the annular waveguide unit includes a through hole formed in the wall of the annular waveguide unit, and a signal transmission conductor insulated from the wall of the annular waveguide unit, the signal transmission conductor being inserted from outside the annular waveguide unit through the through hole into the annular waveguide unit.

In the waveguide-type rat race circuit according to the present invention, in each of the configurations described above, the annular waveguide unit includes an upper main conductor layer disposed on an upper surface of a waveguide dielectric layer and serving as the upper wall of the annular waveguide unit; a lower main conductor layer disposed on a lower surface of the waveguide dielectric layer and serving as the lower wall of the annular waveguide unit; and an inner feedthrough conductor group and an outer feedthrough conductor group each including feedthrough conductors that are arranged at intervals less than half a wavelength of a high-frequency signal transmitted through the annular waveguide unit such that the upper main conductor layer and the lower main conductor layer are electrically connected to each other. The inner feedthrough conductor group serves as an inner side wall of the annular waveguide unit, and the outer feedthrough conductor group serves as an outer side wall of the annular waveguide unit. The annular waveguide unit is a dielectric waveguide line in which a high-frequency signal is transmitted by a region surrounded by the upper main conductor layer, the lower main conductor layer, the inner feedthrough conductor group, and the outer feedthrough conductor group.

In a mixer according to the present invention, in the waveguide-type rat race circuit having any of the configurations described above, two ports being the first port and the third port or two ports being the second port and the fourth port are configured to serve as input ports, and the other two ports are configured to serve as internal output ports. A nonlinear device is connected at one end to at least one of the two internal output ports, and connected at the other end to an external output port. The mixer is capable of mixing high-frequency signals input from the respective two input ports and outputting the resulting signal from the external output port.

In a mixer according to the present invention, in the waveguide-type rat race circuit having any of the configurations described above, two ports being the first port and the third port or two ports being the second port and the fourth port are configured to serve as input ports, and the other two ports are configured to serve as internal output ports. Two nonlinear devices are connected at one end to the respective two internal output ports, and connected to each other at the other end and further connected to an external output port. The mixer is capable of mixing high-frequency signals input from the respective two input ports and outputting the resulting signal from the external output port.

### ADVANTAGEOUS EFFECTS OF INVENTION

In the waveguide-type rat race circuit according to the present invention, the amount of phase shift in each of the first waveguide section, the second waveguide section, and the third waveguide section is (2n+1)π/2, and a difference between a sum of the amounts of phase shift in the first waveguide section, the second waveguide section, and the third waveguide section and the amount of phase shift in the fourth waveguide section is 2(m−1)π, where n and m are natural numbers. It is thus possible to increase a distance between the first port and the second port, between the second port and the third port, and between the third port and the fourth port, and to reduce a distance between the fourth port and the first port. Thus, since a waveguide-type annular transmission line can be easily produced without unnecessarily increasing its size, it is possible to realize a compact waveguide-type rat race circuit.

Also in the waveguide-type rat race circuit according to the present invention, when the annular upper and lower walls of the annular waveguide unit each serve as an H-plane, and at least one of the first to fourth ports is formed in the upper wall or the lower wall of the annular waveguide unit, there is a large degree of freedom in positioning each port. It is thus possible to provide a large degree of freedom in configuration of a transmission line for inputting or outputting a high-frequency signal to or from the rat race circuit.

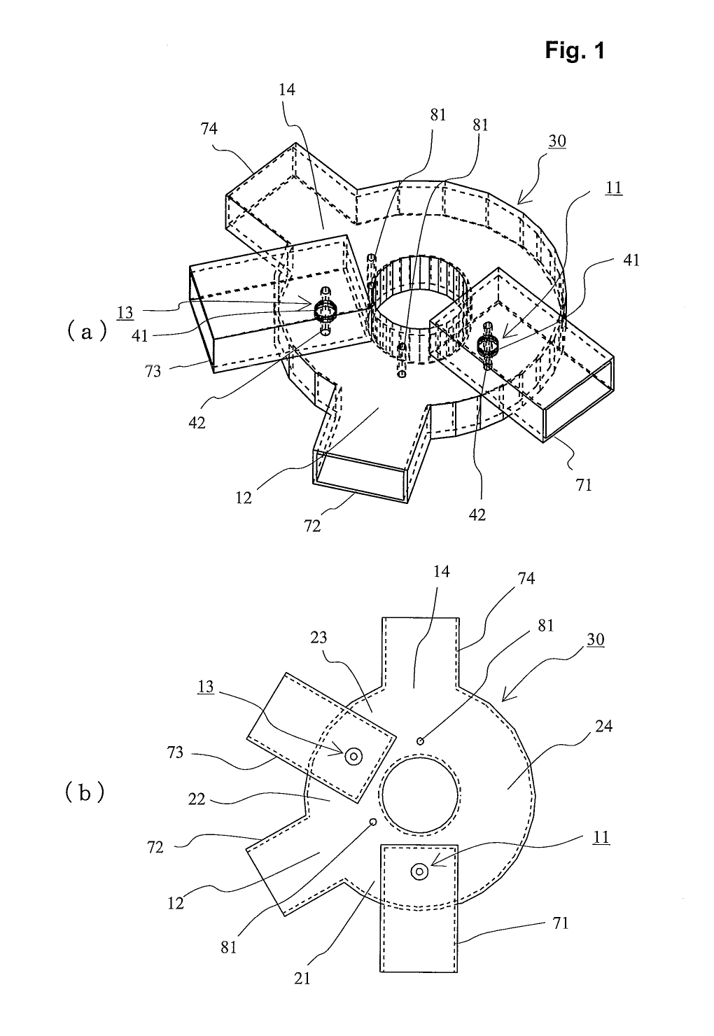

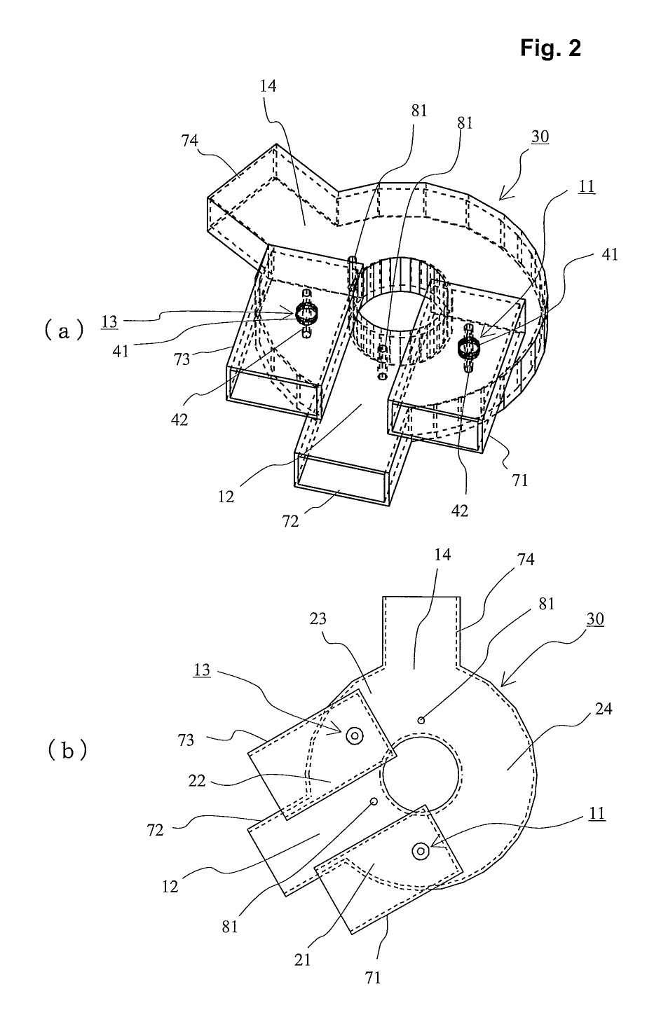

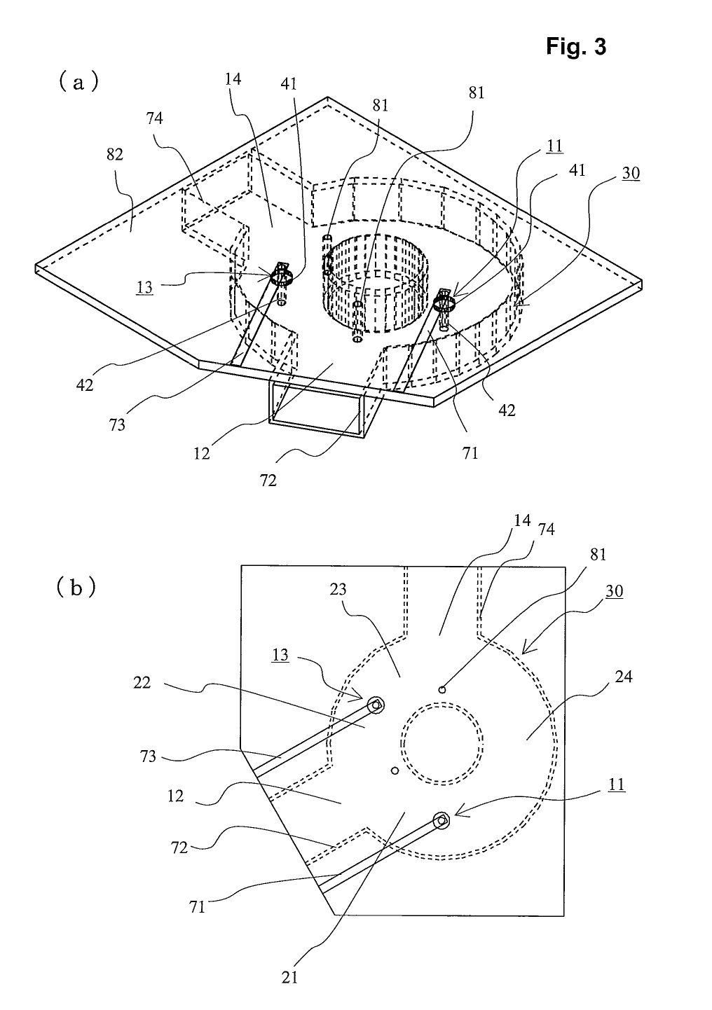

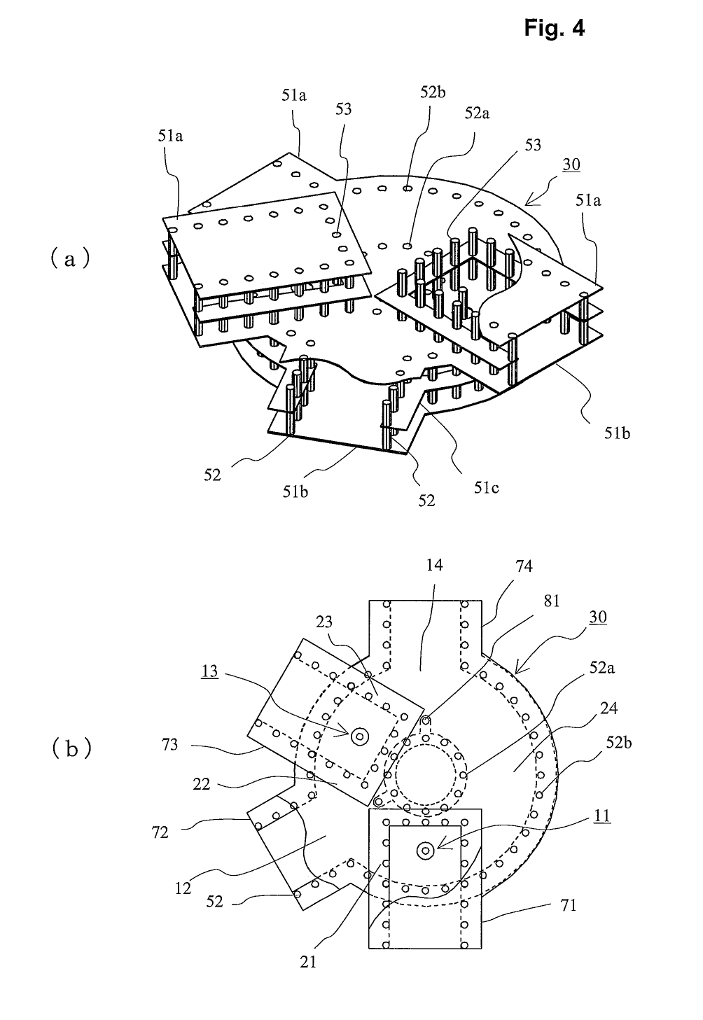

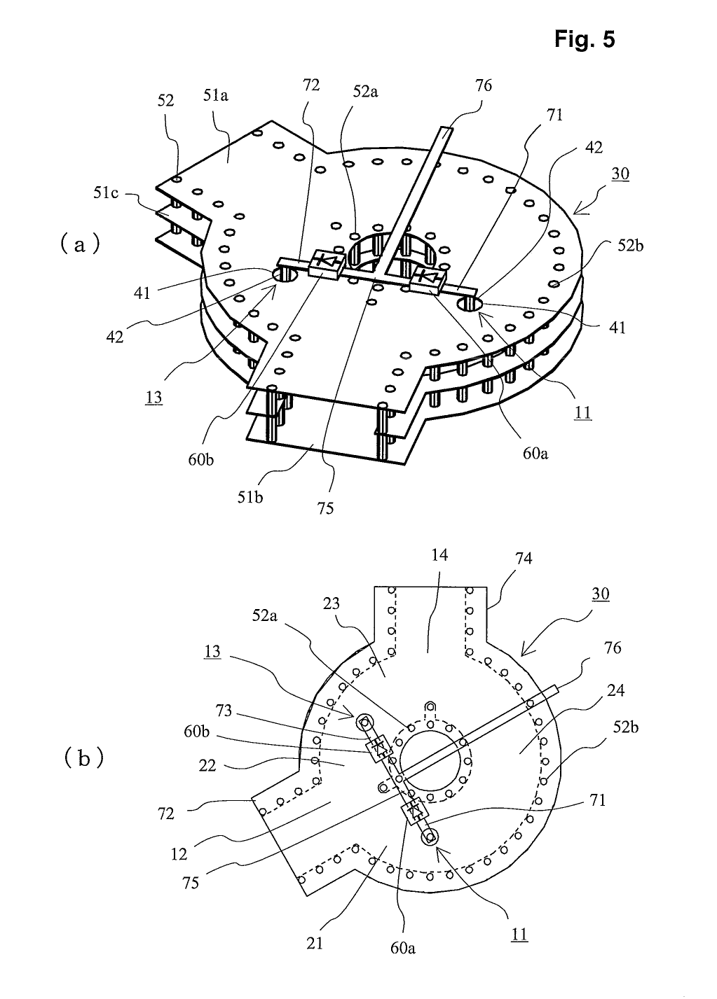

### BRIEF DESCRIPTION OF DRAWINGS

[FIG. 1] FIG. 1(a) is a perspective view schematically illustrating a waveguide-type rat race circuit according to a first embodiment of the present invention. FIG. 1(b) is a schematic plan view of the waveguide-type rat race circuit illustrated in FIG. 1(a).

[FIG. 2] FIG. 2(a) is a perspective view schematically illustrating a modification of the waveguide-type rat race circuit illustrated in FIG. 1(a). FIG. 2(b) is a schematic plan view of the waveguide-type rat race circuit illustrated in FIG. 2(a).

[FIG. 3] FIG. 3(a) is a perspective view schematically illustrating a waveguide-type rat race circuit according to a second embodiment of the present invention. FIG. 3(b) is a schematic plan view of the waveguide-type rat race circuit illustrated in FIG. 3(a).

[FIG. 4] FIG. 4(a) is a perspective view schematically illustrating a waveguide-type rat race circuit according to a third embodiment of the present invention. FIG. 4(b) is a schematic plan view of the waveguide-type rat race circuit illustrated in FIG. 4(a).

[FIG. 5] FIG. 5(a) is a perspective view schematically illustrating a mixer according to a fourth embodiment of the present invention. FIG. 5(b) is a schematic plan view of the mixer illustrated in FIG. 5(a).

### DESCRIPTION OF EMBODIMENTS

A waveguide-type rat race circuit according to the present invention will now be described in detail with reference to the attached drawings.

### First Embodiment

FIG. 1(a) is a perspective view schematically illustrating a waveguide-type rat race circuit according to a first embodiment of the present invention. FIG. 1(b) is a schematic plan view of the waveguide-type rat race circuit illustrated in FIG. 1(a). FIG. 2(a) is a perspective view schematically illustrating a modification of the waveguide-type rat race circuit illustrated in FIG. 1(a). FIG. 2(b) is a schematic plan view of the waveguide-type rat race circuit illustrated in FIG. 2(a).

In the waveguide-type rat race circuit of the present embodiment, as illustrated in FIG. 1(a) and FIG. 1(b), an annular waveguide unit 30 is provided with a first port 11, a second port 12, a third port 13, and a fourth port 14 spaced from each other. The annular waveguide unit 30 is divided into a first waveguide section 21 that connects the first port 11 and the second port 12, a second waveguide section 22 that connects the second port 12 and the third port 13, a third waveguide section 23 that connects the third port 13 and the fourth port 14, and a fourth waveguide section 24 that connects the fourth port 14 and the first port 11. At frequencies used by the waveguide-type rat race circuit of the present embodiment, the amount of phase shift in each of the first waveguide section 21, the second waveguide section 22, and the third waveguide section 23 is set to 3π/2, and the amount of phase shift in the fourth waveguide section 24 is set to 9π/2. Therefore, a difference between a sum of the amounts of phase shift in the first waveguide section 21, the second waveguide section 22, and the third waveguide section 23 and the amount of phase shift in the fourth waveguide section 24 is zero. To realize such amounts of phase shift, the length of each of the first waveguide section 21, the second waveguide section 22, and the third waveguide section 23 is substantially set to 3λ/4, and the length of the fourth waveguide section 24 is substantially set to 9π/4, where λ is a wavelength of a high-frequency signal within the annular waveguide unit 30 at frequencies used by the rat race circuit.

The annular upper and lower walls of the annular waveguide unit 30 each serve as an H-plane. The first port 11 and the third port 13 each include a through hole 41 formed in the upper wall of the annular waveguide unit 30, and a signal transmission conductor 42 insulated from the wall of the annular waveguide unit 30. The signal transmission conductor 42 is inserted from outside the annular waveguide unit 30, through the through hole 41, into the annular waveguide unit 30. A first input/output transmission line 71 for inputting or outputting a high-frequency signal to or from the first port 11 of the annular waveguide unit 30 is disposed on the first port 11. Similarly, a third input/output transmission line 73 for inputting or outputting a high-frequency signal to or from the third port 13 of the annular waveguide unit 30 is disposed on the third port 13. The first input/output transmission line 71 and the third input/output transmission line 73 are constituted by waveguides. The signal transmission conductor 42 of the first port 11 is inserted through a through hole in a lower wall of the first input/output transmission line 71 into the first input/output transmission line 71, so that a high-frequency signal is transmitted through the signal transmission conductor 42. The signal transmission conductor 42 of the third port 13 is inserted through a through hole in a lower wall of the third input/output transmission line 73 into the third input/output transmission line 73, so that a high-frequency signal is transmitted through the signal transmission conductor 42. The signal transmission conductors 42 are insulated from walls of the waveguides constituting the first input/output transmission line 71 and the second input/output transmission line 72.

The second port 12 and the fourth port 14 are constituted by openings in an outer side wall of the annular waveguide unit 30. A second input/output transmission line 72 for inputting or outputting a high-frequency signal to or from the second port 12 is connected to the second port 12. A fourth input/output transmission line 74 for inputting or outputting a high-frequency signal to or from the fourth port 14 is connected to the fourth port 14. The second input/output transmission line 72 and the fourth input/output transmission line 74 are constituted by waveguides formed integrally with the annular waveguide unit 30.

In the waveguide-type rat race circuit of the present embodiment, the annular waveguide unit 30 is provided with matching pins 81 located near the inner radius thereof and at respective positions inside the second port 12 and the fourth port 14. The matching pins 81 are columnar conductors that connect the upper and lower walls of the annular waveguide unit 30. The matching pins 81 provide good impedance matching between the second input/output transmission line 72 and the annular waveguide unit 30, and between the fourth input/output transmission line 74 and the annular waveguide unit 30. Good impedance matching can also be achieved by width adjustment at a connection between the second input/output transmission line 72 and the annular waveguide unit 30 and at a connection between the fourth input/output transmission line 74 and the annular waveguide unit 30.

In the waveguide-type rat race circuit of the present embodiment having the configuration described above, for example, a high-frequency signal input through the first input/output transmission line 71 to the first port 11 is divided into two high-frequency signals to be transmitted in opposite directions in the annular waveguide unit 30. One of the two high-frequency signals is transmitted toward the first waveguide section 21 and the other is transmitted toward the fourth waveguide section 24. Although the two high-frequency signals are in phase at the second port 12 and the fourth port 14, they are out of phase at the third port 13. Therefore, a high-frequency signal is output from the second input/output transmission line 72 and the fourth input/output transmission line 74, but is not output from the third input/output transmission line 73. Thus, the waveguide-type rat race circuit of the present embodiment functions as a rat race circuit.

In the waveguide-type rat race circuit of the present embodiment, a waveguide that suffers less transmission loss in a high-frequency region is used as an annular transmission line that constitutes the rat race circuit. It is thus possible to realize a waveguide-type rat race circuit having good electrical characteristics in a high-frequency region.

In the waveguide-type rat race circuit of the present embodiment, at frequencies used, the amount of phase shift in each of the first waveguide section 21, the second waveguide section 22, and the third waveguide section 23 is set to 3π/2, and the amount of phase shift in the fourth waveguide section 24 is set to 9π/2. Therefore, the length of each of the first waveguide section 21, the second waveguide section 22, and the third waveguide section 23 is substantially set to 3λ/4, and the length of the fourth waveguide section 24 is substantially set to 9λ/4, where λ is a wavelength of a high-frequency signal within the annular waveguide unit 30. Thus, a distance between the first port 11 and the second port 12, a distance between the second port 12 and the third port 13, and a distance between the third port 13 and the fourth port 14 can be made larger than those in the known rat race circuit including four ports, three λ/4 lines, and one 3λ/4 line. This not only makes it possible to easily form a waveguide-type annular transmission line, but also allows input/output transmission lines constituted by waveguides to be connected to respective ports in the outer periphery of the waveguide-type annular transmission line. Additionally, if the fourth waveguide section 24 is a 5λ/4 line and each of the first waveguide section 21, the second waveguide section 22, and the third waveguide section 23 is a 3λ/4 line, a distance between the fourth port 14 and the first port 11 can be made smaller than that in a rat race circuit obtained by tripling the size of the known rat race circuit including three λ/4 lines and one 3λ/4 line. Thus, a compact waveguide-type rat race circuit can be realized.

In the waveguide-type rat race circuit of the present embodiment, the annular upper and lower walls of the annular waveguide unit 30 each serve as an H-plane, and the first port 11 and the third port 13 are in the upper wall of the annular waveguide unit 30. This can provide more degrees of freedom of the position and orientation of the first input/output transmission line 71 and the third input/output transmission line 73.

Also in the waveguide-type rat race circuit of the present embodiment, the first port 11 and the third port 13 each include the through hole 41 formed in the wall of the annular waveguide unit 30, and the signal transmission conductor 42 insulated from the wall of the annular waveguide unit 30. The signal transmission conductor 42 is inserted from outside the annular waveguide unit 30, through the through hole 41, into the annular waveguide unit 30. A high-frequency signal is input or output through the signal transmission conductor 42. Thus, the first input/output transmission line 71 and the third input/output transmission line 73 connected to the first port 11 and the third port 13, respectively, can be set to any orientation. For example, as illustrated in FIG. 2(a) and FIG. 2(b), the first input/output transmission line 71 and the third input/output transmission line 73 can be set to an orientation exactly the same as that of the second input/output transmission line 72. Conversely, the first input/output transmission line 71 and the third input/output transmission line 73 can be easily set to an orientation exactly opposite that of the second input/output transmission line 72. Thus, it is possible to dramatically increase the degree of freedom in the arrangement of transmission lines and components around the waveguide-type rat race circuit.

### Second Embodiment

FIG. 3(a) is a perspective view schematically illustrating a waveguide-type rat race circuit according to a second embodiment of the present invention. FIG. 3(b) is a schematic plan view of the waveguide-type rat race circuit illustrated in FIG. 3(a). In the present embodiment, a description will be given only of differences from the first embodiment described above. The same components are denoted by the same reference numerals, and a redundant description will be omitted.

In the waveguide-type rat race circuit of the present embodiment, a dielectric substrate 82 having a ground conductor layer (not shown) on the lower surface thereof is disposed over the annular waveguide unit 30, the second input/output transmission line 72, and the fourth input/output transmission line 74. Each of the first input/output transmission line 71 and the third input/output transmission line 73 connected to the first port 11 and the third port 13, respectively, is constituted by a microstrip line composed of a ground conductor (not shown), the dielectric substrate 82, and a line conductor on the upper surface of the dielectric substrate 82. In the waveguide-type rat race circuit of the present embodiment having the configuration described above, it is possible to further increase the degree of freedom in the arrangement of transmission lines and components around the waveguide-type rat race circuit.

### Third Embodiment

FIG. 4(a) is a perspective view schematically illustrating a waveguide-type rat race circuit according to a third embodiment of the present invention. FIG. 4(b) is a schematic plan view of the waveguide-type rat race circuit illustrated in FIG. 4(a). To make an internal structure of the waveguide-type rat race circuit easily viewable, the illustration of a waveguide dielectric layer included in the waveguide-type rat race circuit is omitted in FIG. 4(a) and FIG. 4(b). In FIG. 4(a), an upper main conductor layer 51a is illustrated in a partially removed state. In the present embodiment, a description will be given only of differences from the first embodiment described above. The same components are denoted by the same reference numerals, and a redundant description will be omitted.

In the waveguide-type rat race circuit of the present embodiment, the annular waveguide unit 30 is constituted by a dielectric waveguide line. The dielectric waveguide line constituting the annular waveguide unit 30 includes the upper main conductor layer 51a disposed on the upper surface of the waveguide dielectric layer (not shown) and serving as the upper wall of the annular waveguide unit 30, a lower main conductor layer 51b disposed on the lower surface of the waveguide dielectric layer and serving as the lower wall of the annular waveguide unit 30, an inner feedthrough conductor group 52a serving as an inner side wall of the annular waveguide unit 30, and an outer feedthrough conductor group 52b serving as an outer side wall of the annular waveguide unit 30. Feedthrough conductors in both the inner feedthrough conductor group 52a and the outer feedthrough conductor group 52b are arranged at intervals less than half a wavelength of a high-frequency signal transmitted through the annular waveguide unit 30 such that the upper main conductor layer 51a and the lower main conductor layer 51b are electrically connected to each other. In the dielectric waveguide line constituting the annular waveguide unit 30, a high-frequency signal is transmitted by a region surrounded by the upper main conductor layer 51a, the lower main conductor layer 51b, the inner feedthrough conductor group 52a, and the outer feedthrough conductor group 52b. To prevent leakage of a high-frequency signal from the inner feedthrough conductor group 52a, a sub conductor layer 51c that connects the feedthrough conductors included in the inner feedthrough conductor group 52a is provided between the upper main conductor layer 51a and the lower main conductor layer 51b. Also, to prevent leakage of a high-frequency signal from the outer feedthrough conductor group 52b, the sub conductor layer 51c that connects the feedthrough conductors included in the outer feedthrough conductor group 52b is provided between the upper main conductor layer 51a and the lower main conductor layer 51b.

Similarly, the first to fourth input/output transmission lines 71 to 74 are constituted by dielectric waveguide lines. The dielectric waveguide lines constituting the input/output transmission lines 71 to 74 each include the upper main conductor layer 51a disposed on the upper surface of the waveguide dielectric layer (not shown) and serving as the upper wall of the transmission line, the lower main conductor layer 51b disposed on the lower surface of the waveguide dielectric layer and serving as the lower wall of the transmission line, and two rows of side-wall feedthrough conductor groups 52 serving as side walls of the transmission line and including feedthrough conductors that are arranged at intervals less than half a wavelength of a high-frequency signal transmitted through the transmission line such that the upper main conductor layer 51a and the lower main conductor layer 51b are electrically connected to each other. In the dielectric waveguide lines constituting the input/output transmission lines 71 to 74, a high-frequency signal is transmitted by a region surrounded by the upper main conductor layer 51a, the lower main conductor layer 51b, and the two rows of side-wall feedthrough conductor groups 52. In the dielectric waveguide lines constituting the input/output transmission lines 71 to 74, there is also the sub conductor layer 51c that connects the feedthrough conductors included in the two rows of side-wall feedthrough conductor groups 52. At a termination of each of the first input/output transmission line 71 and the third input/output transmission line 73, an end-face feedthrough conductor group 53 is provided in which feedthrough conductors are arranged at intervals less than half a wavelength of a high-frequency signal transmitted through the transmission line such that the upper main conductor layer 51a and the lower main conductor layer 51b are electrically connected to each other.

The annular waveguide unit 30 and the input/output transmission lines 71 to 74 are formed integrally. Specifically, the upper main conductor layers 51a of the annular waveguide unit 30, the second input/output transmission line 72, and the fourth input/output transmission line 74 are formed integrally, and the lower main conductor layers 51b of the annular waveguide unit 30, the second input/output transmission line 72, and the fourth input/output transmission line 74 are formed integrally. Also, the upper main conductor layer 51a of the annular waveguide unit 30 is formed integrally with the lower main conductor layers 51b of the first input/output transmission line 71 and the third input/output transmission line 73.

In the waveguide-type rat race circuit of the present embodiment having the configuration described above, the annular waveguide unit 30 and the first to fourth input/output transmission lines 71 to 74 can be reduced in size, and can be easily formed in a dielectric. It is thus possible to realize a waveguide-type rat race circuit that can be reduced in size and has good manufacturability.

### Fourth Embodiment

FIG. 5(a) is a perspective view schematically illustrating a mixer according to a fourth embodiment of the present invention. FIG. 5(b) is a schematic plan view of the mixer illustrated in FIG. 5(a). To make a structure of the mixer easily viewable, the illustration of the waveguide dielectric layer included in the waveguide-type rat race circuit and the dielectric substrate disposed on the upper surface of the waveguide-type rat race circuit is omitted in FIG. 5(a) and FIG. 5(b). In the present embodiment, a description will be given only of differences from the third embodiment described above. The same components are denoted by the same reference numerals, and a redundant description will be omitted.

In the mixer of the present embodiment, the dielectric substrate (not shown) having a ground conductor layer on the lower surface thereof is disposed on the upper surface of the annular waveguide unit 30, the second input/output transmission line 72, and the fourth input/output transmission line 74. Each of the first input/output transmission line 71 and the third input/output transmission line 73 connected to the first port 11 and the third port 13, respectively, is constituted by a microstrip line composed of the dielectric substrate (not shown) and a line conductor on the upper surface of the dielectric substrate.

The anode of a diode 60a is connected to the first input/output transmission line 71, and the cathode of a diode 60b is connected to the third input/output transmission line 73. The cathode of the diode 60a and the anode of the diode 60b are connected by a connecting transmission line 75, to which an output transmission line 76 is connected. The connecting transmission line 75 and the output transmission line 76 each are constituted by a microstrip line composed of the dielectric substrate (not shown) having the ground conductor layer on the lower surface thereof and a line conductor on the upper surface of the dielectric substrate.

In the mixer of the present embodiment having the configuration described above, for example, when a high-frequency signal having a frequency f1 is input through the second input/output transmission line 72 to the second port 12 and a high-frequency signal having a frequency f2 is input through the fourth input/output transmission line 74 to the fourth port 14, an electric signal having a frequency |f1-f2| can be output from the output transmission line 76. Thus, the mixer of the present embodiment can function as a mixer.

Also in the mixer of the present embodiment, in a region of the output transmission line 76 near a connection between the output transmission line 76 and the connecting transmission line 75, the region being inside the inner feedthrough conductor group 52a of the annular waveguide unit 30, the upper main conductor layer 51a constituting the microstrip line is absent. Since this increases the impedance of this region, a high-frequency signal transmitted through the annular waveguide unit 30 can be prevented from leaking through the output transmission line 76.

Also in the mixer of the present embodiment, an annular transmission line included in the rat race circuit is the annular waveguide unit 30 constituted by a laminated waveguide line. The diodes 60a and 60b are connected to the annular waveguide unit 30 through the signal transmission conductors 42 electromagnetically coupled to the annular waveguide unit 30. Thus, the diodes 60a and 60b and the rat race circuit are not connected in a state which allows conduction of direct current. This means that even when a direct-current bias is applied to the diodes 60a and 60b, it is possible to prevent the direct-current bias from flowing into the rat race circuit. Since this eliminates the need for a coupler and other components used to prevent the direct-current bias from flowing into the rat race circuit, a compact mixer can be realized. To prevent a high-frequency signal from leaking into a direct-current bias circuit, the ground conductor layer on the lower surface of the dielectric layer (not shown) directly below a part of a transmission line constituting the direct-current bias circuit can be removed in an area other than the upper main conductor layer 51a forming the annular waveguide unit 30. This increases the impedance of this area, and prevents a high-frequency signal from leaking into the direct-current bias circuit. Since this eliminates the need for a filter and other components for preventing leakage of a high-frequency signal, it is possible to realize a compact mixer.

When a laminated waveguide line is used in the waveguide-type rat race circuit described above, a relative dielectric constant of the waveguide dielectric layer is, for example, from about 2 to 20. The waveguide dielectric layer may be made of any material which has the property of not interfering with the transmission of a high-frequency signal. Although resin, such as glass epoxy resin, can be used as a material of the waveguide dielectric layer, it is preferable to use dielectric ceramic in terms of manufacturability and accuracy in forming the laminated waveguide line. The upper main conductor layer 51a, the lower main conductor layer 51b, and the sub conductor layer 11c are made of highly conductive metal and are, for example, about 3 μm to 50 μm in thickness. To prevent leakage of a high-frequency signal, it is necessary that the feedthrough conductors in the inner feedthrough conductor group 52a, the outer feedthrough conductor group 52b, and the side-wall feedthrough conductor groups 52 be arranged at intervals less than half (preferably quarter) a wavelength of a high-frequency signal transmitted through the laminated waveguide line. Via holes or through holes which are, for example, about 0.05 mm to 0.5 mm in diameter can be used as the feedthrough conductors in the inner feedthrough conductor group 52a, the outer feedthrough conductor group 52b, and the side-wall feedthrough conductor groups 52.

When the waveguide-type rat race circuit described above is constituted by a laminated waveguide line, the waveguide-type rat race circuit can be made, for example, by the following process. First, ceramic green sheets are produced, for example, by a doctor blade method or a calendar roll method, using slurry obtained by mixing an appropriate organic solvent and a solvent with ceramic raw powder composed mainly of glass, alumina, or aluminum nitride. Next, through holes for forming the inner feedthrough conductor group 52a, the outer feedthrough conductor group 52b, and the side-wall feedthrough conductor groups 52 are created in the resulting ceramic green sheets by a punching machine or the like. Next, metal powder and an appropriate oxide (e.g., alumina, silica, or magnesia oxide) or an appropriate organic solvent are mixed into a paste, which is then put into the through holes and applied to surfaces of the ceramic green sheets by thick-film screen printing. Thus, the ceramic green sheets with conductive paste are made. Next, the ceramic green sheets with conductive paste are stacked and press-bonded by a hot pressing machine into a laminated body. The resulting laminated body is fired at a peak temperature of about 850° C. to 1000° C. if the dielectric layer is made of glass ceramic, at a peak temperature of about 1500° C. to 1700° C. if the dielectric layer is made of alumina ceramic, or at a peak temperature of about 1600° C. to 1900° C. if the dielectric layer is made of aluminum nitride ceramic. The waveguide-type rat race circuit described above can thus be made. If the dielectric layer is made of glass ceramic, the metal powder is preferably copper, gold, or silver powder. If the dielectric layer is made of alumina ceramic or aluminum nitride ceramic, the metal powder is preferably tungsten or molybdenum powder.

### Modifications

The present invention is not limited to the embodiments described above, and can be variously changed or modified without departing from the scope of the present invention.

For example, although the first port 11 and the third port 13 are formed in the upper wall of the annular waveguide unit 30 in the embodiments described above, different ports may be formed in the upper wall of the annular waveguide unit 30. Alternatively, the ports may be formed in the lower wall of the annular waveguide unit 30, or all the ports may be formed in the side wall of the annular waveguide unit 30.

In the embodiments described above, each of the ports in the upper wall of the annular waveguide unit 30 includes the through hole 41 formed in the wall of the annular waveguide unit 30, and the signal transmission conductor 42 insulated from the wall of the annular waveguide unit 30 and passing through the through hole 41. However, the present invention is not limited to this. For example, each port may be a slot in the wall of the waveguide.

Although the laminated waveguide line includes the sub conductor layer 51c in the third and fourth embodiments described above, a laminated waveguide line without the sub conductor layer 51c may be used.

In the fourth embodiment described above, the first port 11 and the third port 13 are connected as internal output ports to the diodes 60a and 60b, respectively. Alternatively, the second port 12 and the fourth port 14 may be connected as internal output ports to the diodes 60a and 60b, respectively. In the latter case, a high-frequency signal may be input to each of the first port 11 and the third port 13.

Also in the fourth embodiment described above, the first port 11 and the third port 13 are connected as internal output ports to the diodes 60a and 60b, respectively. Alternatively, only one of the first port 11 and the third port 13 may be used as an internal output port. In this case, one of the first port 11 and the third port 13 may be connected to one end of a nonlinear device, and the other end of the nonlinear device may be connected as an output port to the output transmission line 76. Then, the other of the first port 11 and the third port 13 is preferably connected to a reflection-free termination.

Also in the fourth embodiment described above, the diodes 60a and 60b are used as nonlinear devices. However, the present invention is not limited to this. That is, other nonlinear devices, such as transistors, may be used.

### REFERENCE SIGNS LIST

11: first port
12: second port
13: third port
14: fourth port
21: first waveguide section
22: second waveguide section
23: third waveguide section
24: fourth waveguide section
30: annular waveguide unit
41: through hole
42: signal transmission conductor
51a: upper main conductor layer
51b: lower main conductor layer
52a: inner feedthrough conductor group
52b: outer feedthrough conductor group

1. A waveguide-type rat race circuit comprising:
an annular waveguide unit; and
a first port, a second port, a third port, and a fourth port spaced from each other in wall of the annular waveguide unit,
wherein the annular waveguide unit is divided into a first waveguide section that connects the first port and the second port, a second waveguide section that connects the second port and the third port, a third waveguide section that connects the third port and the fourth port, and a fourth waveguide section that connects the fourth port and the first port; and
wherein at operating frequency, the amount of phase shift in each of the first waveguide section, the second waveguide section, and the third waveguide section is (2n+1)π/2, where n is a natural number; and a difference between a sum of the amounts of phase shift in the first waveguide section, the second waveguide section, and the third waveguide section and the amount of phase shift in the fourth waveguide section is 2(m−1)π, where m is a natural number.

2. The waveguide-type rat race circuit according to claim 1, wherein annular upper and lower walls of the annular waveguide unit each serve as an H-plane, and at least one of the first to fourth ports is formed in the upper wall or the lower wall of the annular waveguide unit.

3. The waveguide-type rat race circuit according to claim 2, wherein the port in the upper wall or the lower wall of the annular waveguide unit includes a through hole formed in the wall of the annular waveguide unit, and a signal transmission conductor insulated from the wall of the annular waveguide unit, the signal transmission conductor being inserted from outside the annular waveguide unit through the through hole into the annular waveguide unit.

4. The waveguide-type rat race circuit according to claim 1, wherein the annular waveguide unit includes a dielectric layer; an upper main conductor layer disposed on an upper surface of the dielectric layer and serving as the upper wall of the annular waveguide unit; a lower main conductor layer disposed on a lower surface of the dielectric layer and serving as the lower wall of the annular waveguide unit; and an inner feedthrough conductor group and an outer feedthrough conductor group each including feedthrough conductors that are arranged at intervals less than half a wavelength of a high-frequency signal transmitted through the annular waveguide unit such that the upper main conductor layer and the lower main conductor layer are electrically connected to each other, the inner feedthrough conductor group serving as an inner side wall of the annular waveguide unit, the outer feedthrough conductor group serving as an outer side wall of the annular waveguide unit; and wherein the annular waveguide unit is a dielectric waveguide line in which a high-frequency signal is transmitted by a region surrounded by the upper main conductor layer, the lower main conductor layer, the inner feedthrough conductor group, and the outer feedthrough conductor group.

5. A mixer comprising:
the waveguide-type rat race circuit according to claim 1, wherein two ports being the first port and the third port or two ports being the second port and the fourth port are configured to serve as input ports, and the other two ports are configured to serve as internal output ports; and
a nonlinear element connected at one end to at least one of the two internal output ports, and connected at the other end to an external output port,
wherein the mixer is capable of mixing high-frequency signals input from the respective two input ports and outputting the resulting signal from the external output port.

6. A mixer comprising:
the waveguide-type rat race circuit according to claim 1, wherein two ports being the first port and the third port or two ports being the second port and the fourth port are configured to serve as input ports, and the other two ports are configured to serve as internal output ports; and
two nonlinear elements connected at one end to the respective two internal output ports, and connected to each other at the other end and further connected to an external output port, wherein the mixer is capable of mixing high-frequency signals input from the respective two input ports and outputting the resulting signal from the external output port.

7. The waveguide-type rat race circuit according to claim 1, wherein the amount of phase shift in each of the first waveguide section, the second waveguide section, and the third waveguide section is 3π/2; and
a sum of the amounts of phase shift in the first waveguide section, the second waveguide section, and the third waveguide section is equal to the amount of phase shift in the fourth waveguide section.
